(19) United States
(12) Patent Application Publication
(10) Pub. No.: US 2012/0043492 A1
(43) Pub. Date: Feb. 23, 2012

(54) Compositions Containing 1-Chloro-3,3,3 Trifluoropropene And 1-Fluoro-1,1 Dichloroethane

(75) Inventors: David J. WILLIAMS, East Amherst, NY (US); Rajiv R. SINGH, Getzville, NY (US); James M. BOWMAN, Geneva, IL (US)

(73) Assignee: HONEYWELL INTERNATIONAL INC., Morristown, NJ (US)

(21) Appl. No.: 13/210,252

(22) Filed: Aug. 15, 2011

Related U.S. Application Data
(60) Provisional application No. 61/374,496, filed on Aug. 17, 2010.

(51) Int. Cl. E04B 1/78; B08B 1/00; B08B 7/00; C09K 3/00; C11D 7/60

(52) U.S. Cl. 252/62; 252/182.15; 252/182.16; 510/461; 134/31; 134/6; 134/32

(57) ABSTRACT

The instant invention relates to compositions comprising a blend 1-chloro-3,3,3-trifluoropropene (HCFO-1233zd) and 1,1-dichloro-1-fluoroethane (HCFC 141b). In particular, the instant invention relates to blowing agents and foamable compositions containing at least such a blend, as well as solvents containing such a blend.

### CROSS REFERENCES TO RELATED APPLICATIONS

This application claims the benefit of U.S. Provisional patent application Ser. No. 61/374,496 filed Aug. 17, 2010, the contents of which are incorporated herein by reference in its entirety.

### FIELD OF THE INVENTION

This invention relates to compositions, methods and systems having utility in various applications, including as blowing agents and in foamable materials and foams, and as a solvent in various solvent applications. In preferred aspects, the present invention is directed to compositions which comprise at least 1-chloro-3,3,3 trifluoropropene and 1-fluoro-1,1 dichloroethane.

### BACKGROUND OF THE INVENTION

Fluorocarbon based fluids have found widespread use in many commercial and industrial applications, including as aerosol propellants, as solvents, as refrigerants, and as blowing agents. Because of certain suspected environmental problems, including the relatively high global warming potentials and/or ozone depletion potentials associated with the use of some of the compositions that have heretofore been used in these applications, it has become increasingly desirable to use fluids having low or even zero ozone depletion potential, such as hydrofluorocarbons (“HFCs”). Thus, the use of fluids that do not contain substantial amounts of ozone depleting chlorofluorocarbons (“CFCs”) or hydrochlorofluorocarbons (“HCFCs”) is desirable. Furthermore, some HFC fluids may have relatively high global warming potentials associated therewith, and it is desirable to use hydrofluorocarbon or other fluorinated fluids having as low global warming potentials as possible while maintaining the desired performance in use properties.

As suggested above, concern has been increasing in recent years about potential damage to the earth's atmosphere and climate, and certain chlorine-based compounds have been identified as particularly problematic in this regard. The use of chlorine-containing compositions (such as chlorofluorocarbons (CFC's), hydrochlorofluorocarbons (HCF's) and the like) as foam blowing agents and solvents, has become generally disfavored because of the ozone-depleting properties associated with many of such compounds. There has thus been an increasing need for new fluorocarbon and hydrofluorocarbon compounds and combinations of compounds that are attractive alternatives to the compositions heretofore used in these and other applications. For example, it has become desirable to retrofit chlorine-containing systems, such as blowing agent systems or refrigeration systems, by replacing chlorine-containing compounds, at least in part, with non-chlorine-containing compounds that will not deplete the ozone layer, such as hydrofluorocarbons (HFC's). Industry in general is continually seeking new fluorocarbon based mixtures that offer alternatives to, and are considered environmentally safer substitutes for, CFCs and HCFCs. It is considered important in many cases, however, that any potential substitute must also possess those properties present in many of the most widely used fluids, such as imparting excellent thermal insulating properties and other desirable foam characteristics when used as blowing agents, such as appropriate chemical stability, low- or no- toxicity, low or no-flammability, among others. Furthermore, it is generally considered desirable for CFC blowing agent substitutes to be effective without major engineering changes to conventional foam generating systems.

Methods and compositions for making conventional foamed materials, such as for example thermoplastic materials and thermosetting materials, have long been known. These methods and compositions have typically utilized chemical and/or physical blowing agents to form the foamed structure in a polymeric matrix. Such blowing agents have included, for example, azeotropic compounds, water, and various volatile organic compounds (VOCs) (e.g. chlorofluorocarbons (CFCs)). The chemical blowing agents typically undergo some form of chemical change, including chemical reaction with the material that forms the polymer matrix (usually at a predetermined temperature/pressure) that causes the release of a gas, such as nitrogen, carbon dioxide, or carbon monoxide. One of the most frequently used chemical blowing agents is water. The physical blowing agents typically are dissolved in the polymer or polymer precursor material and then expand volumetrically (again at a predetermined temperature/pressure) to contribute to the formation of the foamed structure. Physical blowing agents are frequently used in connection with thermoplastic foams, although chemical blowing agents can be used in place of or in addition to physical blowing agents in connection with thermoplastic foam. For example, it is known to use chemical blowing agents in connection with the formation of polyvinylchloride-based foams. It is common to use chemical blowing and/or physical blowing agents in connection with thermosetting foams. Of course, it is possible that certain compounds and the compositions that contain them may at once constitute a chemical and a physical blowing agent.

In the past, CFCs were used as standard blowing agents in the preparation of isocyanate-based foams, such as rigid and flexible polyurethane and polyisocyanurate foams. For example, CCl₃F (CFC-11) had become a standard blowing agent. However, the use of this material has been banned by international treaty on the grounds that its release into the atmosphere damages the ozone layer in the stratosphere. As a consequence, it is no longer generally common that CFC-11 is used as a standard blowing agent for forming thermosetting foams, such as isocyanate-based foams and phenolic foams.

The problems with CFCs led to the more frequent utilization hydrogen-containing chlorofluoroalkanes (HCFCs). For example, CH₂ClCHClF (HCFC-141b) has a relatively short lifetime in the atmosphere. Such HCFCs are considered to be more environmentally friendly blowing agents relative to CFCs, but compounds still contain some chlorine and a moderate atmospheric lifetime, and therefore have a significant “Ozone Depletion Potential” (called “ODP”). This makes them undesirable to use alone.

Another known class of blowing agents is the non-chlorinated, partially hydrogenated fluorocarbons (called “HFCs”). Certain of the HFCs currently being used as blowing agents have at least one potentially serious problem, namely that they generally have relatively high intrinsic thermal conductivity properties (i.e., poor thermal insulation). On the other hand, foams made with certain of the more modern HFC blowing agents, such as CF₃CH₂CF₂H (“HFC-245fa”) offer improved thermal insulation, due in part to the low thermal conductivity of HFC-245fa vapor, and due in part to the fine cell structure HFC-245fa imparts to the foams. HFC-245fa has been widely used in insulation applications, particularly refrigerator, freezer, refrigerator/freezer and spray foam applications. Nevertheless, many HFC fluids share the disadvantage of having relatively high global warming potentials, and it is desirable to use hydrofluorocarbon or other fluorinated fluids having as low global warming potentials as possible while maintaining the desired performance in use properties. Even the more modern HFCs, such as HFC-245fa, HFC-134a, HFC-365mfc, and others, exhibit a higher than desirable global warming potential, albeit low relative to other HFCs. Thus, the use of HFCs as blowing agents in foam insulation, particularly rigid foam insulation, has resulted in HFCs being less desirable candidates for blowing agents in commercial foam insulation.

Hydrocarbon blowing agents are also known. For example, U.S. Pat. No. 5,182,309 to Hutzen teaches the use of iso- and normal-pentane in various emulsion mixtures. Another example of hydrocarbon blowing agents is cyclopentane, as taught by U.S. Pat. No. 5,096,933-Volkert. Although many hydrocarbon blowing agents, such as cyclopentane, and isomers of pentane, are zero ozone depleting agents and exhibit very low global warming potential, such material are less than fully desirable because foams produced from these blowing agents lack the same degree of thermal insulation efficiency as foams made with, for example, HFC-245fa blowing agent. Further, the hydrocarbon blowing agents are extremely flammable, which is undesirable. Also, certain hydrocarbon blowing agents have inadequate miscibility in certain situations with material from which the foam is formed, such as many of the polyester polyols commonly used in polyisocyanurate modified polyurethane foam. The use of these alkanes frequently requires a chemical surfactant to obtain a suitable mixture.

There has thus been an increasing need for new compounds or combination of compounds and compositions that are attractive alternatives to the compositions heretofore used as blowing agents in these and other applications. Applicants have thus recognized a need for new fluorocarbon based compounds and compositions that offer effective alternatives to, and are considered environmentally safer substitutes for, CFCs and HCFCs. It is generally considered highly desirable, however, that any potential substitute must also possess properties, or impart properties to the foam, that are at least comparable to those associated with many of the most widely used blowing agents, such as vapor phase thermal conductivity, low foam k-factor, low- or no- toxicity, among others.

One such other potentially important property in many applications is flammability. That is, it is considered either important or essential in many applications, including particularly in blowing agent applications, to use compositions which are of low flammability or are non-flammable. As used herein, the term “nonflammable” refers to compounds or compositions which are determined to be nonflammable as determined in accordance with ASTM standard E-681, dated 2002, which is incorporated herein by reference. Unfortunately, many HFC's which might otherwise be desirable for used in blowing agent and solvent compositions are not nonflammable. For example, the fluoroalkane difluoroethane (HFC-152a) and the fluoroalkene 1,1,1-trifluorpropene (HFO-1243zf) are each flammable and therefore not viable for use in many applications.

It has been suggested to use bromine-containing halocarbon additives to decrease flammability of certain materials, including foam blowing agents, in U.S. Pat. No. 5,900,185-Tapscott. The additives in this patent are said to be characterized by high efficiency and short atmospheric lifetimes, that is, low ozone depletion potential (ODP) and a low global warming potential (GWP).

While the brominated olefins described in Tapscott may have some level of effectiveness as anti-flammability agents in connection with certain materials, there is no disclosure of the use of such materials as a blowing agent. Furthermore, it is believed that such compounds may also have certain disadvantages. For example, applicants have come to recognize that many of the compounds identified in Tapscott will have a relatively low efficiency as a blowing agent due to the relatively high molecular weight of such compounds. In addition, it is believed that many of the compounds disclosed in Tapscott will encounter problems when used as a blowing agent due to the relatively high boiling point of such compounds. Moreover, it is understood by applicants that many compounds which have a high level of substitution may possess undesirable toxicity properties and/or other undesirable properties, such as potentially environmentally undesirable bioaccumulation.

While Tapscott indicates that bromine-containing alkenes having from 2 to 6 carbon atoms may also contain fluorine substituents, this patent appears to suggest that fluorine-containing compounds are less than fully desirable from the standpoint of environmental safety by noting that “non-fluorine-containing bromoalkanes will have very short atmospheric lifetimes due to reaction with tropospheric hydroxyl free radicals.” (Col. 8,1. 34-39).

Furthermore, it is generally considered desirable for blowing agent substitutes to be effective without major engineering changes to conventional equipment and systems used in foam preparation and formation.

Applicants have thus come to appreciate a need for compositions, and particularly blowing agents, foamable compositions, foamed articles and methods and systems for forming foam, which provide beneficial properties and/or avoid one or more of the disadvantages noted above. Applicants have thus come to appreciate a need for compositions, and particularly blowing agents, that are potentially useful in numerous applications, while avoiding one or more of the disadvantages noted above.

This invention relates to compositions, methods and systems having utility in numerous applications, including particularly in connection with compositions, methods, systems and agents relating to polymeric foams and/or solvent.

### SUMMARY OF THE INVENTION

The present invention relates to a composition, preferably in the form of a substantially homogeneous mixture or blend, of at least 1-chloro-3,3,3 trifluoropropene (HCFO-1233zd) and 1-fluoro-1,1 dichloroethane (HCFC-141b), as described herein, and its use as a solvent or blowing agent, particularly within foamable compositions. Compositions of the instant invention include 1-chloro-3,3,3 trifluoropropene (HCFO-1233zd) and 1-fluoro-1,1 dichloroethane (HCFC-141b) and optionally include one or more additional ingredients, which are described in detail below. Applicants to the instant invention have surprisingly discovered such a composition exhibits one or more exceptional features, characteristics and/or properties, including: thermal insulation efficiency (particularly for thermoset foams), dimensional stability, compressive strength, aging of thermal insulation properties, all in addition to the low ozone depletion potential and low global warming potential associated with many of the preferred blowing agents of the present invention. Additional advantages will be readily apparent to one of skill in the art based on the disclosure provided herein.

The HCFO-1233zd may be provided as cis-HCFO-1233zd or as trans-HCFO-1233zd alone. Alternatively, the HCFO-1233zd is a mixture of cis- and trans-HCFO-1233zd, which in preferred embodiments may be provided in a ratio in the range from about between 50:50 trans to cis weight ratio of trans:cis of abot 99.9:0.1.

The component parts of the composition of HCFO-1233zd and HCFC-141b may be provided in any effective amount to achieve the foregoing advantages discussed herein. In one embodiment, the composition includes approximately 20-80 weight % of HCFO-1233zd and approximately 80-20 weight % HCFC-141b. In a further embodiment, the composition includes approximately 40-60 weight % HCFO-1233zd and approximately 40-60 weight % HCFC-141b. In an even further embodiment, the composition includes approximately 45-55 weight % HCFO-1233zd and approximately 55-45 weight % HCFC-141b. In an even further alternative embodiment, the composition includes about 50 weight % HCFO-1233zd and about 50 weight % HCFC-141b.

The compositions of the instant invention may also include one or more adjuvants or additional components, depending upon the intended use. While not limited thereto, adjuvants may include the following: co-blowing agents, co-solvents, surfactants, polymer modifiers, colorants, dyes, solubility enhancers, rheology modifiers, plasticizing agents, flame retardants, flammability suppressants, antibacterial agents, viscosity reduction modifiers, fillers, vapour pressure modifiers, nucleating agents, catalysts, polyols, isocyanates, stabilizers, and any combination of two or more of these.

In certain embodiments, particularly in the context of foaming composition, the adjuvant is at least a co-blowing agent, which may be one or more fluoroalkenes, fluoroalkanes, hydrofluoroolefins, hydrofluorocarbons, hydrochlorofluorocarbons, esters, ethers, alcohols, or hydrocarbons.

The co-blowing agent(s) may, in one embodiment, comprise one or more compounds, other than HCFO-1233zd or HCFC-141b, in accordance with Formula I below:

XCF_{z}R_{3-z} (I)

where X is a C₁, C₂, C₃, C₄, or C₅ unsaturated, substituted or unsubstituted, radical, each R is independently Cl, F, Br, I or H, and z is 1 to 3.

Alternatively, the co-blowing agent(s) may also be comprised one or more compounds, other than HCFO-1233zd, of Formula II below:

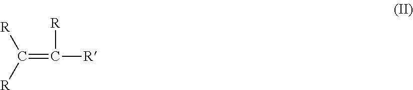

where each R is independently Cl, F, Br, I or H

R′ is (CR₂)ₙY,

Y is CRF₂

and n is 0, 1, 2 or 3.

Based on the foregoing, the co-blowing agent may include at least one fluoroalkene, which may be selected from cis-1,1,1,3-tetrafluoropropene (cis HFO-1234ze), trans-1,1,1,3-tetrafluoropropene (trans HFO-1234ze), and mixtures thereof.

Alternatively, the co-blowing agent may include at least one hydrofluorocarbon (HFC). While not limited thereto, the HFC may have between 1 and 4 carbon atoms and also may be selected from the following: HFC-245fa, HFC-245eb, HFC-245ca, HFC-227ea, HFC-236ea, HFC-236fa, HFC-134a, HFC-134, HFC-152a, HFC-32, HFC-125, HFC-143a, HFC-365mfc, HFC-161, HFC-43-10mee and any two or more of these.

In an even further embodiment, the co-blowing agent may include at least one hydrocarbon. Such hydrocarbons may include, but are not limited to, propane, butane, isobutane, n-pentane, isopentane, cyclopentane, n-hexane, isohexane, heptane and any two or more of these.

The instant invention is not limited to the foregoing co-blowing agents and additional blowing agents known in the art are contemplated. Such agents may include, but are not limited to, water, methyl formate, methylal, carbon dioxide, trans-1,2-dichloroethylene, ethanol, isopropyl alcohol, and combinations thereof. Additional co-blowing agents that may be used are discussed herein or are otherwise known in the art.

In one aspect, the compositions of the instant invention may be used as a blowing agent, particularly for the manufacture of a foamable composition or thermoset or thermoplastic foam. The foam preferably includes plurality of polymeric cells, as is generally understood in the art. To this end, the foam may be in the form of a block, a slab, a laminate, a rigid foam, an open cell foam, a closed cell foam, a flexible foam, an integral skin foam, or a panel foam. The foam may be a spray applied foam, appliance foam (e.g. refrigerator foam, freezer foam, water heater foam, etc.), or the like. In further embodiments, the foam may be a pour foam, for example a discontinuous or continuous panel foam or an insulated transportation container foam.

In one embodiment, the foamable composition is a thermoset foam component selected from components capable of forming polyurethane foam, polyisocyanurate foam, phenolic foam, and two or more of these. To this end the foamable composition may be provided in a foam premix, as is customary in the art.

In an alternative embodiment of the invention, the blend of HCFO-1233zd and HCFC-141b can be used as a solvent. More particularly, it may be used in cleaning various surfaces or removing a contaminant from the surface of an article. Such a solvent may be used as the blend, alone, or otherwise combined with one or more additional components (e.g. co-solvents, inert ingredients, adjuvants, etc.) that are otherwise known in the art. Methods of using the blend as a solvent include wiping, vapour degreasing, spraying, dipping or otherwise immersing the soiled article with the solvent.

Additional embodiments and compositions of the instant invention will be readily apparent to one of skill in the art based on the disclosure provided herein.

### DETAILED DESCRIPTION OF THE INVENTION

The present invention relates to a blend of at least 1-chloro-3,3,3 trifluoropropene (HCFO-1233zd) and 1-fluoro-1,1 dichloroethane (HCFC-141b), as described herein, and its use as a blowing agent within foamable compositions or as a solvent. Compositions of the instant invention include the foregoing blend and optionally include one or more additional ingredients, which are described in detail below. Applicants to the instant invention have surprisingly discovered such a blend exhibits one or more additional exceptional features, characteristics and/or properties, including: thermal insulation efficiency (particularly for thermoset foams), dimensional stability, compressive strength, aging of thermal insulation properties, all in addition to the low ozone depletion potential and low global warming potential associated with many of the preferred blowing agents of the present invention. Additional advantages will be readily apparent to one of skill in the art based on the disclosure provided herein.

The term “HCFO-1233zd” is used herein to generically refer the compound 1-chloro-3,3,3 trifluoropropene (or 1,1,1 trifluoro-3-chloro-2-propene) and includes cis-HCFO-1233zd or trans-HCFO-1233zd. It, therefore, includes within its scope either cis-HCFO-1233zd or trans-HCFO-1233zd alone, but may also include combinations and mixtures of these. In the latter context, the ratio of cis- to trans-HCFO-1233zd may be between 50 wt % to 50 wt % and 99 to 1 wt %, but the instant invention is not necessarily limited thereto.

The term “HCFC-141b” is used herein to generically refer to the compound 1,1-dichloro-1-fluoroethane, 1-fluoro-1,1,-dichloroethane or dichlorofluoroethane.

The component parts of the blend (e.g. HCFO-1233zd and HCFC-141b) may be respectively provided in any effective amount to achieve the aspects disclosed herein. As used herein, the term “effective amount” may include any amount that facilitates the final use of the blend as a blowing agent or solvent or otherwise achieves the advantages discussed herein, particularly, though not exclusively, in the context of a thermoset foam. In certain embodiments, the blend is comprised of about 20 to about 80 wt % of HCFO-1233zd and about 80 to about 20 wt % HCFC-141b. In further embodiments, the blend is comprised of about 40 to about 60 wt % of HCFO-1233zd and about 60 to about 40 wt % HCFC-141b. In even further embodiments, the blend is comprised of about 45 to about 55 wt % of HCFO-1233zd and about 55 to about 45 wt % HCFC-141b. In even further alternative embodiments, the blend is comprised of about 50 wt of HCFO-1233zd and about 50 wt % HCFC-141b.

It is contemplated that in certain embodiments of the present invention the compositions consist of or consist essentially of a blend of the compounds HCFO-1233zd and HCFC-141b, as provided above. Thus, the present invention includes methods and systems which include using such a blend as a blowing agent or solvent without the presence of any substantial amount of additional components being used for such purposes. In alternative embodiments, however, one or more additional compounds or components may also be optionally provided as additional agents or adjuvants. Such optional additional compounds include, but are not limited to, other compounds which also act as blowing agents (hereinafter referred to for convenience but not by way of limitation as co-blowing agents), co-solvents, surfactants, polymer modifiers, colorants, dyes, solubility enhancers, rheology modifiers, plasticizing agents, flame retardants, flammability suppressants, antibacterial agents, viscosity reduction modifiers, fillers, vapor pressure modifiers, nucleating agents, catalysts, polyols, isocyanates, stabilizers, and the like. It will also be appreciated that such certain components may be added which exhibit multiple properties. For example, it is contemplated that the blend may also impart some other beneficial property to the foamable composition to which it is added, e.g. it may also act as a polymer modifier, viscosity reduction modifier, etc.

In embodiments where the composition acts as a blowing agent, one or multiple co-blowing agents may be provided in the composition. Co-blowing agents in accordance with the present invention may comprise a physical blowing agent, a chemical blowing agent (which preferably in certain embodiments comprises water) or a blowing agent having a combination of physical and chemical blowing agent properties. Although it is contemplated that a wide range of co-blowing agents may be used in accordance with the present invention, in certain embodiments, such co-blowing agents may include fluoroalkenes, fluoroalkanes, hydrofluoroolefins, hydrofluorocarbons, hydrochlorofluorocarbons, esters, ethers, alcohols, water, or hydrocarbons, each in addition to a blend of HCFO-1233zd and HCFC-141b.

In one embodiment, for example, the co-blowing agent is comprised of one or more fluoroalkenes in addition to HCFO-1233zd. Such fluoroalkenes may contain from 2 to 6, 3 to 5 carbon atoms, or 3 to 4 carbon atoms and also include one or multiple carbon to carbon double bonds. In certain embodiments, the fluoroalkenes contain three carbon atoms and at least one carbon-carbon double bond. Such embodiments may be referred to herein, for the purpose of convenience, as hydrofluoroolefins or “HFOs” if they contain at least one hydrogen. It is contemplated that the HFOs of the present invention are not necessarily so limited and may also contain greater than three carbon atoms and two or more carbon to carbon double bonds. Also for convenience, HFOs containing at least one chlorine atom, are designated as HCFO.

Such additional fluoroalkene co-blowing agents may, in one embodiment, comprise one or more compounds, other than HCFO-1233zd or HCFC-141b, in accordance with Formula I below:

XCF_{z}R_{3-z} (I)

where X is a C₁, C₂, C₃, C₄, or C₅ unsaturated, substituted or unsubstituted, radical, each R is independently Cl, F, Br, I or H, and z is 1 to 3, it generally being preferred that the fluoroalkene of the present invention has at least four (4) halogen substituents, at least three of which are F and even more preferably none of which are Br.

In certain embodiments, the compounds of Formula I are propenes, butenes, pentenes and hexenes having from 3 to 5 fluorine substituents, with other substituents being either present or not present. In further embodiments, no R is Br, and preferably the unsaturated radical contains no Br substituents.

In alternative embodiments, the additional fluoroalkene co-blowing agent may be comprised of one or more compounds, other than HCFO-1233zd, of Formula II below:

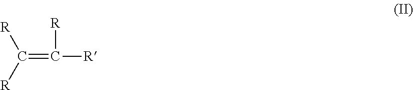

where each R is independently Cl, F, Br, I or H

R′ is (CR₂)ₙY,

Y is CRF₂

and n is 0, 1, 2 or 3, preferably 0 or 1, it being generally preferred however that either Br is not present in the compound or when Br is present in the compound there is no hydrogen in the compound.

Based on the foregoing formulas, in one embodiment, the co-blowing agents include one or more tetrafluoropropenes, such as, but not limited to, HFO-1234. Embodiments of HFO-1234 include, but are not limited to, 1,1,1,2-tetrafluoropropene (HFO-1234yf) and/or 1,1,1,3-tetrafluoropropene (HFO-1234ze), and may also include any and all isomers thereof. HFO-1234ze is used herein generically to refer to 1,1,1,3-tetrafluoropropene and is inclusived of both the cis- and trans- forms and all isomers thereof. Additional tetrafluoropropenes will be readily apparent to one of skill in the art.

In another embodiment the co-blowing agents include one or more and chlorofluoropropenes. Such agents may include, but are not limited to, HCFO-1233 (other than HCFO-1233zd). For example, in one embodiment, the co-blowing agent is a trifluoromonochloropropene other than HCFO-1233zd. One such trifluoromonochloropropene is 1,1,1,trifluoro-2,chloro-propene (HCFO-1233xf). Additional fluorochloropropenes will be readily apparent to one of skill in the art.

In even further embodiments, the co-blowing agents may include one or more pentafluoropropenes, particularly where there is a hydrogen substituent on the terminal unsaturated carbon, e.g. HFO-1225. Such agents may include, but are not limited to, 1,1,1,2,3 pentafluoropropene (HFO-1225yez), both cis- and trans- forms and all isomers thereof. The term HFO-1225yez is thus used herein generically to refer to 1,1,1,2,3 pentafluoropropene, independent of whether it is the cis- or trans- form.

In even further embodiments, the co-blowing agents may include one or more hexafluorobutenes, particularly where there is no hydrogen substituent on the terminal unsaturated carbon, e.g. HFO-1336. Such blowing agents may include, but are not limited to, 1,1,1,3,3,3 hexafluorobutene (HFO-1336mzzm), both cis- and trans- forms and all isomers thereof. The term HFO-1336mzzm is thus used herein generically to refer to 1,1,1,3,3,3 hexafluorobutene, independent of whether it is the cis- or trans- form

In even further embodiments, the co-blowing agents may include one or more butenes. Fluorochlorobutenes are especially preferred in certain embodiments.

In an alternative embodiment, the co-blowing agents of the present invention include one or more fluoroalkanes, including hydrofluorocarbons or “HFCs”. Such co-blowing agents may include hydrocarbons containing between 1 and six carbon atoms and one or more fluorine atoms. In one embodiment the HFCs contain between one and four hydrocarbons. In alternative embodiments, the HFCs contain between four and six hydrocarbons. Exemplified, though non-limiting, HFCs include one or more of difluoromethane (HFC-32), fluoroethane (HFC-161), difluoroethane (HFC-152), trifluoroethane (HFC-143), tetrafluoroethane (HFC-134), pentafluoroethane (HFC-125), pentafluoropropane (HFC-245), hexafluoropropane (HFC-236), heptafluoropropane (HFC-227ea), pentafluorobutane (HFC-365), hexafluorobutane (HFC-356) and all isomers thereof. In certain embodiments, one or more of the following HFC isomers are preferred for use as co-blowing agents in the compositions of the present invention:
1,1,1,2,2-pentafluoroethane (HFC-125),
1,1,2,2-tetrafluoroethane (HFC-134),
1,1,1,2-tetrafluoroethane (HFC-134a),
1,1- difluoroethane (HFC-152a),
1,1,1,2,3,3,3-heptafluoropropane (HFC-227ea),
1,1,1,3,3,3-hexafluoropropane (HFC-236fa),
1,1,1,3,3-pentafluoropropane (HFC-245fa),
1,1,1,3,3-pentafluorobutane (HFC-365mfc),
1,1,1,2,3-pentafluoropropane (HFC-245eb),
1,1,2,2,3-pentafluoropropane (HFC-245ca),
1,1,1,2,3,3-hexafluoropropane (HFC-236ea),
1,1,1-trifluoroethane (HFC-143a), and
1,1,1,2,2,3,4,5,5,5-decafluoropentane (HCF-43-10mee).

In even further alternative embodiments, the co-blowing agent may be comprised any hydrocarbon. Such hydrocarbons may include, but are not limited to, a hydrocarbon containing one to six carbon atoms that are straight chained, branch chained, cyclic or acyclic. Exemplified hydrocarbons include, but are not limited to, one or more of propane, butane, isobutene, n-pentane, isopentane, cyclopenane, n-hexane, isohexane, and/or heptane. In certain preferred embodiments, for example, iso, normal and/or cyclopentane may be used for thermoset foams and butane or isobutane for thermoplastic foams.

Additional known co-blowing agents, other than the foregoing, are also available and may be included within the composition of the instant invention. Such other materials may include, for example, water, CO₂, CFCs (such as trichlorofluoromethane (CFC-11) and dichlorodifluoromethane (CFC-12)), hydrochlorocarbons (HCCs such as dichloroethylene (preferably trans-1,2-dichloroethylene), ethyl chloride and chloropropane), HCFCs, C1-C5 alcohols (such as, for example, ethanol and/or propanol and/or butanol), C1-C4 aldehydes, C1-C4 ketones, C1-C4 ethers (including ethers (such as dimethyl ether and diethyl ether), diethers (such as dimethoxy methane or methylal and diethoxy methane)), and esters (such as methyl formate), to name a few. Such agents may be used alone or in any combination.

The relative amount of any of the above noted additional co-blowing agents, as well as any additional components which may be included in present compositions, can vary widely within the general broad scope of the present invention according to the particular application for the composition, and all such relative amounts are considered to be within the scope thereof. While not limited thereto, in one embodiment, co-blowing agents may be provided in an amount that is at least about 1% by weight, at least about 5% by weight, or at least about 15% by weight, of the composition. Again, the instant invention is not so limited and additional amounts of co-blowing agents may also be provided, as discussed below or as otherwise understood in the art.

For compositions which include HFO, HFC, fluoroalkene, fluoroalkane, or hydrocarbon co-blowing agents, such co-blowing agents may be provided in any amount from less than 1% by weight to about 80% by weight of the total blowing agent composition, from about 10% by weight to about 75% by weight, or from about 25% to about 75% by weight of the total blowing agent. Such weight percentages are not limited to the instant invention, however, and may be adapted as required for the intended purpose by one of skill in the art.

In embodiments where water is provided as the co-blowing agent, the composition may comprise water in an amount of from less than 1% by weight to about 50% by weight of the total blowing agent composition, from about 10% by weight to about 40% by weight, or from about 10% to about 20% by weight of the total blowing agent. Such weight percentages are not limited to the instant invention, however, and may be adapted as required for the intended purpose by one of skill in the art.

In embodiments in which the co-blowing agent comprises CO₂, the composition may comprise CO₂ in an amount of from less than 1% by weight to about 60% by weight of the total blowing agent composition, from about 20% by weight to about 50% by weight, or from about 40% to about 50% by weight of the total blowing agent. Such weight percentages are not limited to the instant invention, however, and may be adapted as required for the intended purpose by one of skill in the art.

In embodiments where the co-blowing agent comprises alcohols, (preferably C2, C3 and/or C4 alcohols), it may be provided in an amount of from less than 1% by weight to about 40% by weight of the total blowing agent composition, more preferably from about 10% by weight to about 40% by weight, and even more preferably of from about 15% to about 25% by weight of the total blowing agent. Such weight percentages are not limited to the instant invention, however, and may be adapted as required for the intended purpose by one of skill in the art.

In addition to co-blowing agents, the compositions of the instant invention which are to be used as blowing agents may also contain dispersing agents, cell stabilizers, surfactants and other additives which facilitate foam formation. Certain surfactants are optionally but preferably added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458, each of which is incorporated herein by reference.

Other optional additives for the blowing agent mixture may include flame retardants such as tri(2-chloroethyl)phosphate, tri(2-chloropropyl)phosphate, tri(2,3-dibromopropyl)-phosphate, tri(1,3-dichloropropyl) phosphate, diammonium phosphate, various halogenated aromatic compounds, antimony oxide, aluminum trihydrate, polyvinyl chloride, and the like.

With respect to nucleating agents, all known compounds and materials having nucleating functionality are available for use in the present invention, including particularly talc. Of course other compounds and/or components that modulate a particular property of the compositions (such as cost for example) may also be included in the present compositions, and the presence of all such compounds and components is within the broad scope of the invention.

As is known to those skilled in the art, the foamable compositions generally include one or more components capable of forming foam. As used herein, the term “foam foaming agent” or “blowing agent” is used to refer to a component, or a combination on components, which are capable of forming a foam structure, preferably a generally cellular foam structure. The blowing agent of the present invention includes at least the blend of HCFO-1233zd and HCFC-141b, and may also include the one or more of the additional co-blowing agents discussed above or other additional agents discussed herein. In certain embodiments, such components also comprise a thermosetting composition capable of forming foam and/or foamable compositions. Examples of thermosetting compositions include polyurethane and polyisocyanurate foam compositions, and also phenolic foam compositions. This reaction and foaming process may be enhanced through the use of various additives, as discussed above, which may serve to, inter alia, control and adjust cell size and to stabilize the foam structure during formation. Furthermore, it is contemplated that any one or more of the additional components described above with respect to the blowing agent compositions of the present invention could be incorporated into the foamable composition of the present invention. In such thermosetting foam embodiments, one or more of the present compositions are included as or part of a blowing agent in a foamable composition, or as a part of a two or more part foamable composition, which preferably includes one or more of the components capable of reacting and/or foaming under the proper conditions to form a foam or cellular structure.

In certain other embodiments of the present invention, the one or more components capable of foaming comprise thermoplastic materials, particularly thermoplastic polymers and/or resins. Examples of thermoplastic foam components include polyolefins, such as for example monovinyl aromatic compounds of the formula Ar—CHCH2 wherein Ar is an aromatic hydrocarbon radical of the benzene series such as polystyrene (PS). Other examples of suitable polyolefin resins in accordance with the invention include the various ethylene resins including the ethylene homopolymers such as polyethylene and ethylene copolymers, polypropylene (PP) and polyethyleneterepthalate (PET). In certain embodiments, the thermoplastic foamable composition is an extrudable composition.

It is contemplated that all presently known and available methods and systems for forming foam are readily adaptable for use in connection with the present invention. For example, the methods of the present invention generally require incorporating a blowing agent in accordance with the present invention into a foamable or foam forming composition and then foaming the composition, preferably by a step or series of steps which include causing volumetric expansion of the blowing agent in accordance with the present invention. In general, it is contemplated that the presently used systems and devices for incorporation of blowing agent and for foaming are readily adaptable for use in accordance with the present invention. In fact, it is believed that one advantage of the present invention is the provision of an improved blowing agent which is generally compatible with existing foaming methods and systems.

It will be appreciated by those skilled in the art that the present invention comprises methods and systems for foaming all types of foams, including thermosetting foams, thermoplastic foams and formed-in-place foams. Thus, one aspect of the present invention is the use of the present blowing agents in connection conventional foaming equipment, such as polyurethane foaming equipment, at conventional processing conditions. The present methods therefore include masterbatch type operations, blending type operations, third stream blowing agent addition, and blowing agent addition at the foam head.

With respect to thermoplastic foams, the preferred methods generally comprise introducing at least the blowing agent blend (e.g. HCFO-1233zd/HCFC-141b) in accordance with the present invention into a thermoplastic material, preferably thermoplastic polymer such as polyolefin, and then subjecting the thermoplastic material to conditions effective to cause foaming. For example, the step of introducing the blowing agent into the thermoplastic material may comprise introducing the blowing agent into a screw extruder containing the thermoplastic, and the step of causing foaming may comprise lowering the pressure on the thermoplastic material and thereby causing expansion of the blowing agent and contributing to the foaming of the material.

It will be appreciated by those skilled in the art, especially in view of the disclosure contained herein, that the order and manner in which the blowing agent of the present invention is formed and/or added to the foamable composition does not generally affect the operability of the present invention. For example, in the case of extrudable foams, it is possible that the various components of the blowing agent, and even the components of the foamable composition, be not be mixed in advance of introduction to the extrusion equipment, or even that the components are not added to the same location in the extrusion equipment. Moreover, the blowing agent can be introduced either directly or as part of a premix, which is then further added to other parts of the foamable composition.

Thus, in certain embodiments it may be desired to introduce one or more components of the blowing agent at first location in the extruder, which is upstream of the place of addition of one or more other components of the blowing agent, with the expectation that the components will come together in the extruder and/or operate more effectively in this manner. Nevertheless, in certain embodiments, two or more components of the blowing agent are combined in advance and introduced together into the foamable composition, either directly or as part of premix which is then further added to other parts of the foamable composition.

One embodiment of the present invention relates to methods of forming foams, and preferably polyurethane and polyisocyanurate foams. The methods generally comprise providing a blowing agent composition of the present inventions, adding (directly or indirectly) the blowing agent composition to a foamable composition, and reacting the foamable composition under the conditions effective to form a foam or cellular structure, as is well known in the art. Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam embodiments of the present invention. In general, such preferred methods comprise preparing polyurethane or polyisocyanurate foams by combining an isocyanate, a polyol or mixture of polyols, a blowing agent or mixture of blowing agents comprising one or more of the present compositions, and other materials such as catalysts, surfactants, and optionally, flame retardants, colorants, or other additives.

It is convenient in many applications to provide the components for polyurethane or polyisocyanurate foams in pre-blended formulations. Most typically, the foam formulation is pre-blended into two components. The isocyanate and optionally certain surfactants and blowing agents comprise the first component, commonly referred to as the “A” component. The polyol or polyol mixture, surfactant, catalysts, blowing agents, flame retardant, and other isocyanate reactive components comprise the second component, commonly referred to as the “B” component. Accordingly, polyurethane or polyisocyanurate foams are readily prepared by bringing together the A and B side components either by hand mix for small preparations and, preferably, machine mix techniques to form blocks, slabs, laminates, panels, pour-in-place panels, containers and other items, spray applied foams, froths, and the like. Optionally, other ingredients such as fire retardants, colorants, auxiliary blowing agents, and even other polyols can be added as one or more additional streams to the mix head or reaction site. Most preferably, however, they are all incorporated into one B-component as described above.

The present methods and systems also include forming a one component foam, preferably polyurethane foam, containing a blowing agent in accordance with the present invention. In certain preferably embodiments, a portion of the blowing agent is contained in the foam forming agent, preferably by being dissolved in a foam forming agent which is liquid at the pressure within the container, a second portion of the blowing agent is present as a separate gas phase. In such systems, the contained/dissolved blowing agent performs, in large part, to cause the expansion of the foam, and the separate gas phase operates to impart propulsive force to the foam forming agent. Such one component systems are typically and preferably packaged in a container, such as an aerosol type can, and the blowing agent of the present invention thus preferably provides for expansion of the foam and/or the energy to transport the foam/foamable material from the package, and preferably both. In certain embodiments, such systems and methods comprise charging the package with a fully formulated system (preferably isocyanate/polyol system) and incorporating a gaseous blowing agent in accordance with the present invention into the package, preferably an aerosol type can.

Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam forming embodiments of the present invention.

It is contemplated also that in certain embodiments it may be desirable to utilize the present compositions when in the supercritical or near supercritical state as a blowing agent.

The invention also relates to all foams, (including but not limited to closed cell foam, open cell foam, rigid foam, flexible foam, integral skin and the like) prepared from a polymer foam formulation containing a blowing agent comprising the compositions of the invention. Applicants have found that one advantage of the foams, and particularly thermoset foams such as polyurethane foams, in accordance with the present invention is the ability to achieve, preferably in connection with thermoset foam embodiments, exceptional thermal performance, such as can be measured by the K-factor or lambda, particularly and preferably under low temperature conditions. Although it is contemplated that the present foams, particularly thermoset foams of the present invention, may be used in a wide variety of applications, in certain preferred embodiments the present invention comprises appliance foams in accordance with the present invention, including refrigerator foams, freezer foams, refrigerator/freezer foams, panel foams, pour-in-place foams, and other cold or cryogenic manufacturing applications. Other preferred embodiments comprise water heater foam and other foams used in above ambient insulation applications.

The foams in accordance with the present invention, in certain preferred embodiments, provide one or more exceptional features, characteristics and/or properties, including: thermal insulation efficiency (particularly for thermoset foams), dimensional stability, compressive strength, aging of thermal insulation properties, all in addition to the low ozone depletion potential and low global warming potential associated with many of the preferred blowing agents of the present invention. In certain highly preferred embodiments, the present invention provides thermoset foam, including such foam formed into foam articles, which exhibit improved thermal conductivity relative to foams made using the same blowing agent (or a commonly used blowing agent HFC-245fa) in the same amount but without the HCFO-1233zd/HCFC-141b blend in accordance with the present invention. In certain highly preferred embodiments, the thermoset foams, and preferably polyurethane foams, of the present invention exhibit a K-factor (BTU in/hr ft²° F.) at 40° F. of not greater than about 0.14, more preferably not greater than 0.135, and even more preferably not greater than 0.13. Furthermore, in certain embodiments, it is preferred that the thermoset foams, and preferably the polyurethane foams of the present invention exhibit a K-factor (BTU in/hr ft²° F.) at 75° F. of not greater than about 0.16, more preferably not greater than 0.15, and even more preferably not greater than 0.145.

In other preferred embodiments, the present foams exhibit improved mechanical properties relative to foams produced with blowing agents outside the scope of the present invention. For example, certain preferred embodiments of the present invention provide foams and foam articles having a compressive strength which is superior to, and preferably at least about 10 relative percent, and even more preferably at least about 15 relative percent greater than a foam produced under substantially identical conditions by utilizing a blowing agent consisting of cyclopentane. Furthermore, it is preferred in certain embodiments that the foams produced in accordance with the present invention have compressive strengths that are on a commercial basis comparable to the compressive strength produced by making a foam under substantially the same conditions. In certain preferred embodiments, the foams of the present invention exhibit a compressive strength of at least about 12.5% yield (in the parallel and perpendicular directions), and even more preferably at least about 13% yield in each of said directions.

In alternative embodiments of the invention, the blend of HCFO-1233zd and HCFC-141b can be used as a solvent. More particularly, it may be used in cleaning various surfaces or removing a contaminant from the surface of an article. Such a solvent may be used as the blend, alone, or otherwise combined with one or more additional components (e.g. co-solvents, inert ingredients, etc) that are otherwise known in the art. Methods of using the blend as a solvent include wiping, vapor degreasing, spraying, dipping or otherwise immersing the soiled article with the solvent.

### EXAMPLES

### Example 1

An ebulliometer consisting of vacuum-jacketed tube with a condenser on top was used. About 15.6 grams of HCFC-141b was charged to the ebulliometer and HCFO-1233zd(E) was added in small measured increments. The temperature was measured using a platinum resistance thermometer. As shown in Table 1, below, at no time did the boiling point of the composition remain constant or nearly constant as more HCFO-1233zd(E) was added. Therefore, the composition does not boil as a constant-boiling composition over this range and is not azeotropic.

TABLE 1
Ebulliometer study of HCFC-141b/HCFO-1233zd(E)

| Wt. % | Wt. % HCFO- | |
|---|---|---|
| 141b | 1233zd(E) | T (C.) |
| 100.00 | 0.00 | 31.10 |
| 99.81 | 0.19 | 31.01 |
| 95.71 | 4.29 | 29.59 |
| 87.37 | 12.63 | 27.03 |
| 83.27 | 16.73 | 26.11 |
| 77.99 | 22.01 | 25.15 |
| 72.90 | 27.10 | |
| 67.75 | 32.25 | 23.54 |
| 45.50 | 54.50 | 21.00 |

### Example 2

Rigid polyurethane foams are prepared using the formulation shown in Table 2, below. The foams are prepared by a general procedure commonly referred to as “handmixing”. For each blowing agent or blowing agent pair, a premix of polyol, surfactant, and catalysts is prepared in the same proportions displayed in Table 2. The total moles of blowing agent are held constant. About 100 grams of each formulation is blended. The premix is blended in a 32 oz paint can, and stirred at about 1500 rpm with a Conn 2″ diameter ITC mixer until a homogeneous blend is achieved. When mixing is complete, the can is covered and placed in a refrigerator controlled at 50° F. The foam blowing agent or pre-blended pair of blowing agents is also stored in pressure bottles at 50° F. The A- component is kept in sealed containers at 70° F.

The pre-cooled blowing agent is added in the required amount to the premix. The contents are stirred for two minutes with a Conn 2″ ITC mixing blade turning at 1000 rpm. Following this, the mixing vessel and contents are re-weighed. If there is a weight loss, the blowing agent or the blend is added to the solution to make up any weight loss. The can is then covered and replaced in the refrigerator.

After the contents have cooled again to 50° F., approximately 10 minutes, the mixing vessel is removed from refrigerator and taken to the mixing station. A pre-weighted portion of A-component, isocyanurate, is added quickly to the B-component, the ingredients mixed for 10 seconds using a Conn 2″ diameter ITC mixing blade at 3000 rpm and poured into a 8″×8″×4″cardboard cake box and allowed to rise. Cream, initiation, gel and tack free times are recorded for the individual polyurethane foam samples.

The foams are allowed to cure in the boxes at room temperature for at least 24 hours. After curing, the blocks are trimmed to a uniform size and densities measured. Any foam that does not meet the density specification 2.0±0.11b/ft³ are discarded and new foams are prepared.

After ensuring that all the foams meet the density specifications, the foams are tested for k-factor according to ASTM C518. The k-factor results are listed in Table 2. This table shows that the k-factor and dimensional stability of a foam produced with the mixture of HCFC-141b and HCFO-1233zd(E) is unexpectedly improved than that achieved with either material neat. This is particularly unusual since the two materials are not azeotropic in nature.

TABLE 2

| | | 75/25 Wt/Wt | 50/50 Wt/Wt | 25/75 Wt/Wt | |
|---|---|---|---|---|---|
| | 100% | HCFC-141b/ | HCFC-141b/ | HCFC-141b/ | 100% HCFO- |
| B-side (wt. %) | HCFC-141b | HCFO-1233zd(E) | HCFO-1233zd(E) | HCFO-1233zd(E) | 1233zd(E) |
| Polyol | 100 | 100 | 100 | 100 | 100 |
| Catalyst A | Variable | Variable | Variable | Variable | Variable |
| Catalyst B | Variable | Variable | Variable | Variable | Variable |
| Water | 1.0 | 1.0 | 1.0 | 1.0 | 1.0 |
| Surfactant A | 1.5 | 1.5 | 1.5 | 1.5 | 1.5 |
| Fire retardant | 5.0 | 5.0 | 5.0 | 5.0 | 5.0 |
| HFCO-1233zd(E) | 0 | 6.7 | 13.9 | 21.4 | 29.25 |
| HCFC-141b | 26.3 | 20.3 | 13.9 | 7.1 | 0 |
| Index | 110 | 110 | 110 | 110 | 110 |
| Density | 2.0 | 2.0 | 2.0 | 2.0 | 2.0 |
| k-Factor @ 75° F. | | | | | |
| Initial | 0.140 | 0.138 | 0.135 | 0.138 | 0.140 |
| k-Factor @ 40° F. | | | | | |
| Initial | .1581 | .1559 | .1582 | .1582 | .1612 |
| Dimensional Stability | | | | | |
| 158 F./97% RH, % change | 5.0 | 4.5 | 4.2 | 4.5 | 5.0 |
| in volume @ 1 day | | | | | |
| 158 F./97% RH, % change | 6.5 | 5.5 | 5.2 | 5.7 | 6.0 |
| in volume @ 14 day | | | | | |
| −20 F., change in | −1.0 | −0.7 | −0.3 | −0.5 | −0.7 |
| volume @ 1 day | | | | | |
| −20 F., change in | −0.8 | −0.6 | −0.2 | −0.4 | −0.6 |
| volume @ 14 day | | | | | |

What is claimed is:

1. A composition comprising 1-chloro-3,3,3-trifluoropropene (HCFO-1233zd) and 1,1-dichloro-1-fluoroethane (HCFC 141b).

2. The composition according to claim 1, wherein the HCFO-1233zd is cis-HCFO-1233zd.

3. The composition according to claim 1, wherein the HCFO-1233zd is trans-HCFO-1233zd.

4. The composition according to claim 1, wherein the HCFO-1233zd is a mixture of cis- and trans-HCFO-1233zd.

5. The composition according to claim 4, wherein the ratio of cis- to trans-HCFO-1233zd is in the range between 50 wt % to 50 wt % and 99 to 1 wt %.

6. The composition according to claim 1, comprising 20-80 weight % of HCFO-1233zd and 80-20 weight % HCFC-141b.

7. The composition according to claim 6, comprising 40-60 weight % HCFO-1233zd and 40-60 weight % HCFC-141b.

8. The composition according to claim 6, comprising 45-55 weight % HCFO-1233zd and 55-45 weight % HCFC-141b.

9. The composition according to claim 6, comprising about 50 weight % HCFO-1233zd and about 50 weight % HCFC-141b.

10. The composition according to claim 1, further comprising at least one adjuvant selected from co-blowing agents, co-solvent, surfactants, polymer modifiers, colorants, dyes, solubility enhancers, rheology modifiers, plasticizing agents, flame retardants, flammability suppressants, antibacterial agents, viscosity reduction modifiers, fillers, vapour pressure modifiers, nucleating agents, catalysts, polyols, isocyanates, stabilizers, and any combination of two or more of these.

11. The composition according to claim 10, wherein the adjuvant is a co-blowing agent.

12. The composition according to claim 11, wherein the co-blowing agent comprises one or more compounds, other than HCFO-1233zd or HCFC-141b, in accordance with Formula I below:
XCF_{z}R_{3-z} (I)
where X is a C₁, C₂, C₃, C₄, or C₅ unsaturated, substituted or unsubstituted, radical, each R is independently Cl, F, Br, I or H, and z is 1 to 3.

13. The composition according to claim 11 wherein the co-blowing agent comprises one or more compounds, other than HCFO-1233zd, of Formula II below: 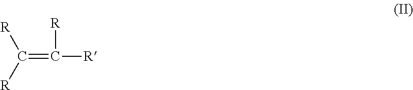
where each R is independently Cl, F, Br, I or H
R′ is (CR₂)ₙY,
Y is CRF₂
and n is 0, 1, 2 or 3,

14. The composition according to claim 11, wherein the co-blowing agent comprises at least one fluoroalkene.

15. The composition according to claim 14, wherein said at least one fluoroalkene is selected from the group consisting of cis-1,1,1,3-tetrafluoropropene (cis HFO-1234ze), trans-1,1,1,3-tetrafluoropropene (trans HFO-1234ze), and mixtures thereof.

16. The composition according to claim 11, wherein the co-blowing agent comprises a hydrofluorocarbon (HFC) having 1 to 4 carbon atoms.

17. The composition according to claim 16, wherein the HFC is selected from HFC-245fa, HFC-245eb, HFC-245ca, HFC-227ea, HFC-236ea, HFC-236fa, HFC-134a, HFC-134, HFC-152a, HFC-32, HFC-125, HFC-143a, HFC-365mfc, HFC-161, HFC-43-10mee and any two or more of these.

18. The composition according to claim 17, wherein the HFC is selected from HFC-245fa, HFC-32, HFC-365mfc, HFC-227ea and any two or more of these.

19. The composition according to claim 11, wherein the co-blowing agent comprises a hydrocarbon.

20. The composition according to claim 19, wherein the hydrocarbon is selected from propane, butane, isobutane, n-pentane, isopentane, cyclopentane, n-hexane, isohexane, heptane and any two or more of these.

21. The composition according to claim 11, wherein the co-blowing agent is selected from the group consisting of water, ethanol, isopropyl alcohol, methyl formate, methylal, carbon dioxide, trans-1,2-dichloroethylene, and combinations thereof.

22. The composition according to claim 21, wherein the co-blowing agent comprises water.

23. Use of a composition according to claim 1, as a blowing agent.

24. Use according to claim 23, for the manufacture of a thermoset or thermoplastic foam.

25. Use according to claim 24, wherein the foam is a spray applied foam.

26. Use according to claim 24, wherein the foam is an appliance foam, for example a refrigerator foam, a freezer foam or water heater foam.

27. Use according to claim 24, wherein the foam is a pour foam, for example a discontinuous or continuous rigid or flexible faced panel foam or an insulated transportation container foam.

28. A foamable composition comprising a foam forming agent, and a blowing agent comprising a composition of claim 1.

29. The foamable composition according to claim 28, wherein said foam forming agent comprises at least one thermoset foam component selected from components capable of forming polyurethane foam, polyisocyanurate foam, phenolic foam, and two or more of these.

30. A foam premix comprising a polyol, and a blowing agent comprising a composition as defined in claim 1.

31. A foam comprising a plurality of polymeric cells and a composition contained in at least one of said cells, said composition being defined in claim 1.

32. The foam according to claim 31, in the form of one or more of a block, a slab, a laminate, a rigid foam, an open cell foam, a closed cell foam, a flexible foam, an integral skin foam, refrigerator foam, and a freezer foam.

33. The foam according to claim 32, wherein the foam is a closed cell foam.

34. The foam according to claim 31, which is a thermoset foam.

35. The foam according to claim 34, wherein the foam is a polyurethane foam, a polyisocyanurate foam or a phenolic foam.

36. The foam according to claim 31, having a k-factor at 40° F. of not greater than 0.14 BTU in./hr.ft².° F.

37. A method of forming a foam, comprising adding to a foamable and/or foaming composition a blowing agent comprising a composition as defined in claim 1.

38. Use of a composition, as defined in claim 1, as a solvent.

39. Use according to claim 38, for removing a contaminant from the surface of an article.

40. Use according to claim 39, in a vapour degreasing method.

41. Use according to claim 38, wherein the composition is sprayed or wiped onto the article to be cleaned.

42. Use according to claim 38, wherein the article to be cleaned is dipped into or immersed in composition.
